(19) United States
(12) Patent Application Publication
(10) Pub. No.: US 2018/0137438 A1
(43) Pub. Date: May 17, 2018

(54) BOOKING OF RENTABLE VEHICLES IN A CAR SHARING SYSTEM

(71) Applicant: DAIMLER AG, Stuttgart (DE)

(72) Inventors: Manuel MONTAG, Berlin (DE); Fabian HEUWIESER, Hamburg (DE); Leander LENZING, Hamburg (DE)

(21) Appl. No.: 15/566,317

(22) PCT Filed: Mar. 5, 2016
(86) PCT No.: PCT/EP2016/000393

§ 371 Date: Oct. 13, 2017

(30) Foreign Application Priority Data
Apr. 16, 2015 (DE) 10 2015 004 806.6

(51) Int. Cl. G06Q 10/02; G06Q 30/06; G06Q 50/30

(52) U.S. Cl. CPC G06Q 10/02; G06Q 50/30; G06Q 30/0645

(57) ABSTRACT

A system includes mobile devices, vehicles to hire, and a central server that exchanges data with the vehicles to hire and mobile devices. The vehicles to hire arranged in a road network, and at least transmit their current positions to the central server. A method using this system involves predefining on one of the mobile devices of a first position in the road network, of a search area around the first position, and of a future condition. The first position, the search area, and the condition are transmitted to the central server. If the condition is fulfilled, the central server determines, for the duration of a predefined time period, whether a vehicle to hire is available in the search area, and if so, information relevant to the vehicle to hire is transmitted to the mobile device. A booking offer is created and issued by the mobile device based on the transmitted information.

### BACKGROUND AND SUMMARY OF THE INVENTION

Exemplary embodiments of the invention relate to the field of so-called “free-floating car-sharing” systems. Such systems typically comprise a central server designed and configured for data exchange with vehicles to hire, and at least one mobile device, wherein the vehicles to hire are operated in a road network and at least transmit their current positions to the central server. In particular, exemplary embodiments of the invention relate to a method for operating such a system and to a system of the same type.

The term “free-floating car sharing” is understood here to mean that a (motor) vehicle to hire within a defined area of use, for example in a road network, can be parked by a user in any free parking space at the end of a hire period. The location of the vehicle in the parking space is transmitted from the respective vehicle to the central server of a fleet operator, and thus up-do-date knowledge of this is available in each case. In this respect, knowledge of the distribution of vehicles to hire in the area of use is indeed up-to-date, but cannot be clearly predicted in the future.

Currently, a customer can search, for example, via smartphone, for vehicles in proximity to him/her that are currently free, and also make current reservations for these. In contrast to this, booking a vehicle for a time further in the future results in a reduction in the current availability of the vehicle fleet.

Exemplary embodiment of the invention are directed to improving the potential uses of a free-floating car-sharing system.

According to a first aspect of the invention, a method for operating a system comprising a central server is provided, which is designed and configured for data exchange with vehicles to hire and mobile devices, wherein the vehicles for hire are operated in a road network and transmit at least their current positions to the central server. The method comprises the following steps.

In a first step, a first position in the road network, a search area around the first position and a future condition are predefined on one of the mobile devices.

The mobile device is advantageously a smartphone or a tablet PC or a mobile computer.

The information/data is advantageously predefined by manual or acoustic input into the mobile device, or by the access to and selection of corresponding data already stored in the mobile device.

The first position can, for example, be predefined in the form of coordinates or as an address in the road network (for example, as location, street or house number).

The search area around the first position is advantageously defined and correspondingly entered as the radius of a circle around the first position, or by predefining a maximum distance that can be covered on foot from the first position, or by a maximum time that may elapse for a route on foot from the first position. The routes on foot are preferably taken on the footpaths provided in the road network.

The condition in the future is advantageously a temporal condition. For example, a predefined time of day, or a predefined time of day in conjunction with a predefined date, or a predefined time of day in conjunction with a predefined day of the week, or a predefined time of day in conjunction with a predefined month, or a predefined time of day in conjunction with a predefined day of the week and a predefined month, or a predefined time of day in conjunction with a predefined year, or a predefined time of day in conjunction with a predefined year, and a predefined month, a predefined time of day in conjunction with a predefined year and a predefined month and a predefined day of the week. Thus, any recurring time points can also be defined, which in particular specify a future time at which a vehicle is to be hired. In particular, regularly occurring hiring wishes can thus also be defined, for example, at 6 pm on weekdays (to drive home from work), or daily at 8 am and 5 pm.

Of course, other conditions can also be predefined, for example, as soon as a particular telephone number is called, as soon as a baby alarm sounds, as soon as a share price rises above a certain price, etc. However, it is necessary in this case for the central server to have the appropriate information that the predefined condition is fulfilled.

In a second step, the first position, the search area, and the condition are transmitted from the mobile device to the central server. This advantageously takes place using mobile internet, GSM network, UMTS network, LTE network, GPRS network, HSDPA network or WLAN. The central server still has information on the position of the vehicles in the road network, wherein it in particular knows the parking positions of the vehicles currently available for hire.

In a third step, if the condition is fulfilled, the central server determines for the duration of a predefined time period Δt1 whether the vehicle to hire is available in the search area, and, if so, the information relevant to the vehicle to hire is transmitted to the mobile device advantageously using mobile internet, GSM network, UMTS network, LTE network, GPRS network, HSDPA network or WLAN. Whether the condition applies is also continuously checked in one variant by the central server, and determined accordingly or, in an alternative variant, continuously checked, accordingly determined and transmitted to the central server by the mobile device when the condition occurs.

If the presence/fulfillment of the condition is determined at a time t₀ by the central server, then for a period from t₀ to t₀+Δt1, it is determined whether a vehicle to hire is available in the search area. The period Δt1 is advantageously in the range of 15 min to 120 min. In particular, it is advantageously 30 min, 45 min, 60 min, 75 min, 90 min or 105 min.

If a vehicle to hire is detected by the central server in the search area in the period from t₀ to t₀+Δt1, the information relevant to the vehicle to hire is transmitted to the mobile device, for example as a push message. This information advantageously includes one or more of the following pieces of information: position or address of the vehicle to hire, vehicle type, number of seats of the vehicle, hire price, tank filling level, maintenance status, booking code, activation code for the vehicle, distance on foot from the current position of the mobile device, e.g. in meters/km, or in walking minutes and/or instructions to the driver.

In a third step, the mobile device is used to create and issue a booking offer based on the transmitted information. The booking offer includes all or some of the information transmitted to the mobile device. A display of the booking offer also advantageously comprises an illustration of a map of the road network with the marked current position of the mobile device and the marked position of the vehicle to hire. More advantageously, a footpath to the vehicle to hire, which is optimized in terms of one or more predefined criteria, is also displayed on the map. These criteria are, for example, the shortest or the fastest route.

The user can bindingly book or reject the booking offer issued by the mobile device, e.g., by further corresponding input(s) into the mobile device and a corresponding transmission of the binding booking or rejection to the central server.

Advantageously, a vehicle to hire detected by the central server is offered exclusively to the mobile device user for a predefined period of time (for example, 5 minutes, 10 minutes, 15 minutes). If no binding booking or rejection is made during this period, the booking offer will become invalid.

If the booking offer is rejected by the user of the mobile device, the central server advantageously continues to detect whether a vehicle to hire is available in the search area until the time t₀+Δt1. If such a second vehicle to hire is detected, an analogous procedure takes place.

If the booking offer is bindingly booked by the user, the vehicle will be available to the user.

The proposed method enables the start of the booking, in the form of a temporal condition, the first position indicating the location at which a vehicle is to be hired, and the search area around the first position to be freely predefined. The method facilitates this without reducing the general availability of the vehicle fleet, or blocking vehicles for too long.

In an advantageous development of the method the predefined first position is the current position of the mobile device. In this regard, the mobile device has a position detection system, for example a GPS, Galileo or GLONASS receiver. Advantageously, the first position and a correspondingly updated area around the first position also continue to be transmitted to the central server, for example every minute, every 2, 5, 10 minutes. In one development, the first position is generally equated to the current position of the mobile device until a position or address is predefined as the first position in the road network

An advantageous development of the method is distinguished by the fact that the central server predicts whether a vehicle to hire is available in the search area when the condition occurs, and that if so, the central server transmits the information relevant to the vehicle to hire to the mobile device for the issuance of a booking offer. The transmission of the booking offer to the mobile device can already take place before the condition occurs.

The prediction of the availability of a vehicle to hire in the search area by the central server is advantageously based on statistics relating to historical data on the availability of a vehicle to hire in the search area under the predefined condition. This data is provided to the central server for this purpose. The historical data advantageously allows an evaluation of the availability of a vehicle to hire in the search area depending on predefined days of the week, times, seasons, holidays, special events (sports events, trade fairs, carnival parades, etc.) and/or the local weather in the search area.

This development of the method facilitates a high availability of the fleet vehicles and an advance booking option with a high level of reliability.

According to a second aspect of the invention, a system comprises a central server, vehicles to hire and, at least one mobile device, wherein the central server is designed and configured for data exchange with the vehicles to hire and the mobile device, and wherein the vehicles to hire are operated in a road network, and at least transmit their current positions to the central server.

In the system the mobile device is designed and configured to predefine a first position in the road network, a search area around the first position, and a future condition, and the mobile device is furthermore designed and configured to transmit the first position, the search area and the condition to the central server, the central server is also designed and configured to determine whether a vehicle to hire is available in the search area if the condition is met for the predefined time period Δt1, and if so, to transmit the information relevant to the vehicle to hire in question to the mobile device, and the mobile device is ultimately designed and configured to create and issue a booking offer based on the transmitted information.

Advantageous developments and explanations of the proposed system result from an analogous and corresponding rendering of the embodiments listed above in connection with the proposed method.

Further advantages, features and details emerge from the following description, in which at least one exemplary embodiment is described in detail, if applicable with reference to the drawing. Identical, similar and/or parts that are identical in function are given the same reference symbols.

### BRIEF DESCRIPTION OF THE DRAWING FIGURES

The following is shown:

FIG. 1 A schematic procedure of the disclosed method, and

FIG. 2 A schematic set-up of the disclosed system.

### DETAILED DESCRIPTION

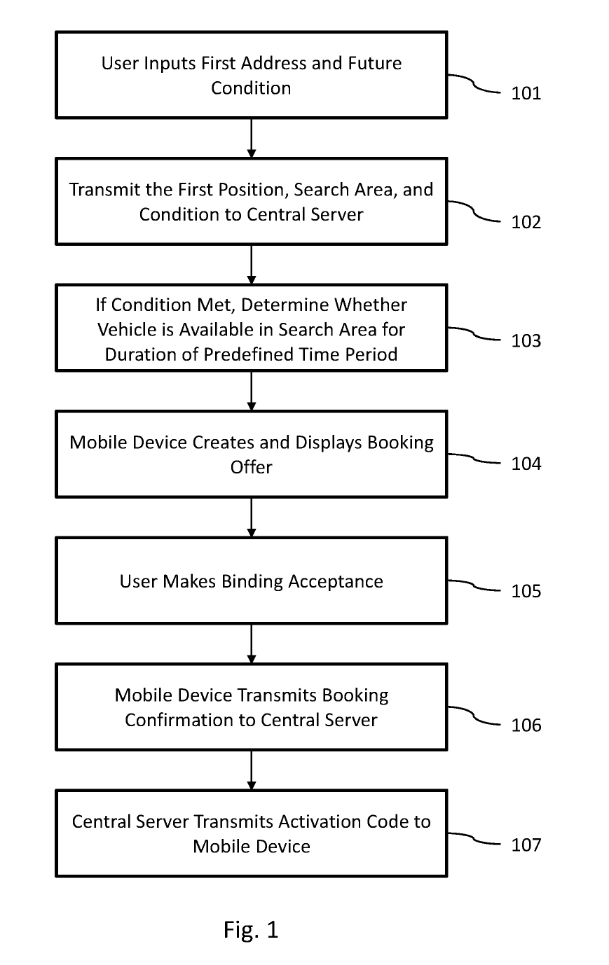

FIG. 1 shows a schematic procedure of a method for operating a system comprising a central server which is designed and configured for the exchange of data with vehicles to hire and mobile devices (e.g., smartphones), wherein the vehicles to hire are operated in a road network, and at least transmit their current positions to the central server. For this purpose, the vehicles are equipped with a position determination unit, in this case a GPS system.

In a first step 101, a first address (location, street, house number) in the road network, a radius of 500 m, which defines a search area around the first position, and a future condition, in this case the time point t_{B} in two hours from the current (input) time tₐₖₜ, t_{B}=tₐₖₜ+2 h, is input by a user on a mobile device.

The mobile device has a corresponding car sharing app. The car sharing app is used to input and output information, to carry out the relevant information processing, and to communicate accordingly with the central server. The mobile device furthermore has a position detection unit (GPS).

In a second step 102, the first position entered by the user, the search area and the condition are transmitted to the central server via mobile internet.

In a third step 103, if the condition is met, i.e., currently t_{B}=tₐₖₜ+2, the central server determines whether a vehicle to hire is available in the search area for the duration of a predefined time period Δt1=1 hour. For this purpose, the position data of the individual vehicles to hire is available to the central server. If a vehicle to hire is detected in the search area, the information concerning the vehicle to hire is transmitted to the mobile device.

In a fourth step 104, the mobile device, i.e. the application software running on it, creates a booking offer based on the transmitted information, and shows it on a display of the mobile device. The displayable booking offer includes e.g., the following information: the position or address of the vehicle to hire (shown as a position in a map section shown on the display), the vehicle type, the number of seats of the vehicle to hire, the hire price, the tank filling level, the maintenance status, the booking code, the distance on foot from the current position of the mobile device to the vehicle to hire e.g. in m/km, or in walking minutes.

In a fifth step 105, the user makes a binding acceptance of the booking offer using a corresponding input into the mobile device.

In a sixth step 106, this booking confirmation is transmitted from the mobile device to the central server, which then in a seventh step 107 on its side transmits an activation code to the mobile device. The activation code can, for example, consist of characters (numbers/letters/other characters) or an optical code, for example a bar or a matrix code, which is used to open and activate the respective vehicle to hire. In this case, the transmission of the activation code to the mobile device is connected with valid payment of a hiring fee.

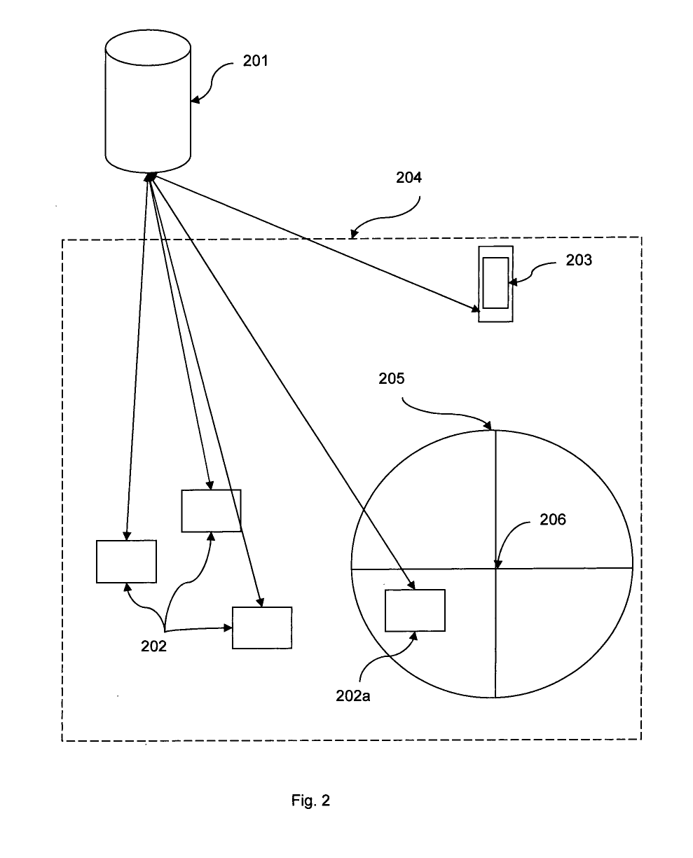

FIG. 2 shows a schematic set-up of a proposed system, comprising a central server 201, motor vehicles to hire 202, 202a, and at least one mobile device 203. The central server 201 is designed and configured for data exchange with the vehicles to hire 202, 202a and the mobile device 203. The central server 201, the vehicles 202, 202a and the mobile device 203 have a radio communication interface for this purpose. The vehicles 202, 202a are operated in a road network 204. The vehicles to hire 202, 202a (schematically shown in FIG. 2.) assigned to the section of the road network and the mobile device 203 are arranged at their respective current positions in the section of the road network.

The vehicles 202, 202a determine their respective current position and transmit this to the central server 201 with a respective vehicle identification.

The mobile device 203 is designed and configured for predefining or inputting a first position 206 in the road network, a search area 205 around the first position 206, and a future condition. The first position indicates the position desired by the user for picking up a vehicle to hire in the road network. The search area (=radar) borders the area around the first position, in which the user is willing to accept a pick-up location of a vehicle to hire. The condition in this case is a future point in time.

After inputting the above information, the mobile device 203 is designed and configured to automatically transmit the first position 206 of the predefined search area 205 and the predefined condition to the central server 201.

The central server 201 is furthermore designed and configured to determine if a vehicle 202a is available to hire in the search area 205 if the condition is fulfilled for the duration of the predefined time period Δt1.

In FIG. 2, the situation where the condition is met is shown. The vehicle 202a is detectably positioned within the search area 205. The central server 201 detects this and transmits the information relevant to the vehicle to hire 202a to the mobile device 203. The mobile device 203 is furthermore designed and configured to create and issue a booking offer based on the transmitted information.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a system comprising a central server for the exchange of data with vehicles to hire and mobile devices, wherein the vehicles to hire are operated in a road network and transmit at least their current positions to the central server, the method comprising:
predefining, on one of the mobile devices, a first position in the road network, a search area around the first position, and a future condition;
transferring the first position, the search area, and the future condition to the central server
determining, by the central server, that the future condition is met for the duration of a predefined time period, and in response determining whether or not a vehicle to hire is available in the search area;
transmitting information relevant to the vehicle to hire to the mobile device responsive to the determination that a vehicle to hire is available in the search area; and
creating and outputting, by the mobile device based on the transmitted information, a booking offer.

12. The method of claim 11, wherein the future condition is a temporal condition and is defined one of:
a predefined time of day;
a predefined time of day for a predefined date;
a predefined time of day for a predefined day of the week;
a predefined time of day for a predefined month;
a predefined time of day for a predefined day of the week and a predefined month;
a predefined time of day for a predefined year;
a predefined time of day for a predefined year and a predefined month; and
a predefined time of day for a predefined year and a predefined month and a predefined day of the week.

13. The method of claim 11, wherein the predefined first position is a current position of the mobile device.

14. The method of claim 13, wherein the first position and a correspondingly updated search area around the first position are repeatedly transmitted to the central server.

15. The method of claim 11, wherein the search area is determined by
inputting a maximum distance that can be covered on foot from the first position, or
a maximum time that may elapse for a route on foot from the first position.

16. The method of claim 11, wherein the predefined time period ranges between 15 min and 120 min.

17. The method of claim 11, wherein when the condition is fulfilled, the central server predicts whether a vehicle to hire is available in the search area, and when the central server predicts that a vehicle to hire is available in the search area, the central server transmits information relevant to the vehicle to hire to the mobile device for issuing a booking offer.

18. The method of claim 17, wherein the prediction is based on statistics relating to historical data on availability of a vehicle to hire in the search area under the predefined condition.

19. A system, comprising:
a central server;
vehicles to hire; and
at least one mobile device,
wherein the central server is configured to exchange data with the vehicles to hire and with the mobile device,
wherein the vehicles to hire are operated in a road network and at least their current positions are transmitted to the central server,
wherein the mobile device is configured to predefine a first position in the road network, a search area around the first position, and a future condition,
wherein the mobile device is configured to transmit the first position, the search area, and the future condition to the central server,
wherein the central server is configured to determine, when the future condition is fulfilled for a duration of a predefined time period, whether a vehicle to hire is available in the search area, and when a vehicle for hire is available in the search area, the central server is configured to transmit information relevant to the vehicle to hire to the mobile device, and
wherein the mobile device is configured to create and issue a booking offer based on the transmitted information.

20. The system of claim 19, wherein the central server is configured to predict whether, when the future condition is fulfilled, a vehicle to hire is available in the search area, and it is predicted that a vehicle to hire is available in the search area, the central server is configured to transmit relevant data regarding the vehicle to hire to the mobile device for issuing a booking offer.
